(19) United States
(12) Patent Application Publication
(10) Pub. No.: US 2025/0376074 A1
(43) Pub. Date: Dec. 11, 2025

(54) CONTROL ARRANGEMENT AND METHOD FOR DETERMINING AN UPPER CHARGING LIMIT FOR AN ENERGY STORAGE DEVICE OF A VEHICLE

(71) Applicant: Scania CV AB, Södertälje (SE)

(72) Inventors: Daniel Ståhl, Enköping (SE); Martin Berglund, Vagnhärad (SE); Magnus Carlgren, Vagnhärad (SE)

(73) Assignee: Scania CV AB, Södertälje (SE)

(21) Appl. No.: 19/217,092

(22) Filed: May 23, 2025

(30) Foreign Application Priority Data
Jun. 5, 2024 (SE) 2450618-0

(51) Int. Cl. B60L 58/15; B60L 53/62

(52) U.S. Cl. CPC B60L 58/15; B60L 53/62; B60L 2240/26; B60L 2240/642; B60L 2260/54

(57) ABSTRACT

Control arrangement and method for determining an upper charging limit for an energy storage device of a vehicle which is to be charged at a charging station. The method comprises determining a state of charge threshold for the energy storage device corresponding to a minimum state of charge sufficient for the vehicle to reach a predicted upcoming regenerative braking event. The method also comprises estimating virtual potential energy invested in the vehicle, wherein said estimation is performed taking into account any planned change in vehicle weight and/or payload. The method further comprises determining a maximum state of charge sufficient to allow the energy storage device to accumulate the estimated virtual potential energy. The method further comprises, when the determined maximum state of charge is higher than the determined state of charge threshold, selecting the determined maximum state of charge as the upper charging limit.

### TECHNICAL FIELD

The present disclosure relates in general to a method for determining an upper charging limit for an energy storage device of a vehicle which is to be charged at a charging station. The present disclosure also relates in general to a method for controlling charging of an energy storage device when charging at a charging station.

The present disclosure further relates in general to a control arrangement configured to determine an upper charging limit for an energy storage device of a vehicle which is to be charged at a charging station.

The present disclosure further relates in general to a computer program as well as a computer-readable medium. Moreover, the present disclosure also relates to a vehicle.

### BACKGROUND

When charging e.g., a heavy-duty battery electric vehicle, it is common to charge it fully, or at least to a high level, to thereby maximize the possible driving range of the vehicle. However, this may reduce the possibility for controlling the vehicle speed using regenerative braking since the energy storage device is not capable of accumulating the energy to be recovered when reaching its maximum storage capacity. Furthermore, regenerative braking performance is generally reduced when the energy storage device reaches a high state of charge, e.g., because the energy storage device no longer can be charged at the same high charging rates when approaching its maximum capacity without risking damaging the energy storage device.

It may be very difficult for a driver to know how much an energy storage device of a vehicle may be charged without risking impairing the possibilities for regenerative braking and still achieve the greatest possible driving range. This may be particularly problematic when the charging station is located at a high altitude, for example in the mountains, and the destination of the vehicle has a lower altitude, for example a harbor.

It has previously been proposed to estimate the braking power needed to maintain a desired vehicle speed in an upcoming downhill and, when needed (and possible), reduce the state of charge, while the vehicle is in motion, prior to the downhill for the purpose of ensuring that the vehicle may be sufficiently braked by regenerative braking. However, such solutions typically rely on waste of energy, which in turn may have a negative effect on the total operational costs of the vehicle over time. It is therefore desirable to seek to reduce the number of instances that such methods may need to be used.

Moreover, it has previously been proposed to charge the energy storage device to a targeted state of charge sufficient for the vehicle to reach its destination, such as a subsequent charging station. These methods typically rely on estimating energy needed for reaching a destination, and based on the estimated needed energy, determine the state of charge to which the energy storage device of the vehicle should be charged (i.e. a target state of charge) at the charging station. However, these methods typically serve the purpose of reducing the duration of charging and/or reducing the risk for aging of the energy storage device, and are therefore not concerned with ensuring the ability to control vehicle speed through regenerative braking.

### SUMMARY

The object of the present invention is to enable assisting a driver to reduce the risk for an energy storage device of a vehicle to be charged to such a state of charge that the ability to use regenerative braking may be impaired.

The object is achieved by the subject-matter of the appended independent claim(s).

The present disclosure provides a method, performed by a control arrangement, for determining an upper charging limit for an energy storage device of a vehicle which is to be charged at a charging station. The method comprises a step of determining a state of charge threshold for the energy storage device, said state of charge threshold corresponding to a minimum state of charge sufficient for the vehicle to reach a predicted upcoming regenerative braking event. The method further comprises a step of estimating virtual potential energy invested in the vehicle, wherein said estimation is performed taking into account any planned change in vehicle weight and/or payload. The method further comprises a step of determining a maximum state of charge sufficient to allow the energy storage device to accumulate the estimated virtual potential energy. Moreover, the method comprises a step of, when the determined maximum state of charge is higher than the determined state of charge threshold, selecting the determined maximum state of charge as the upper charging limit.

The herein described method allows for determining an upper charging limit, which ensures that the vehicle speed may be controlled through regenerative braking, even in case there are planned changed in vehicle weight and/or payload during an upcoming driving assignment. Through knowledge of such an upper charging limit for the energy storage device, it is possible to provide guidance to a driver intending to charge the energy storage device of the vehicle and/or to control the charging process of the energy storage device of the vehicle. Furthermore, through using the determined upper charging limit for assisting a driver when charging the energy storage device, the driver can select to charge the energy storage device to the determined charging limit to thereby enable the greatest possible driving range for the vehicle, should the driver so desire. Charging of the energy storage device to the determined upper charging limit will not substantially negatively affect the possible driving range since the energy missing, compared to the maximum storage capacity of the energy storage device, may be recovered through regenerative braking.

By determining an upper charging limit in accordance with the herein described method, the number of times at which there is a need for waste of energy stored in the energy storage device for the purpose of enabling regenerative braking may be considerably reduced.

In addition to the advantages mentioned above, determining an upper charging limit in accordance with the herein described method may reduce the risk for undue charging at the charging station, which in turn may reduce the charging costs and thus the total cost of operation of the vehicle. The total cost of operation is also reduced through reduction of the need for wasting energy to ensure regenerative braking when performing a driving assignment. Moreover, the lifetime of the energy storage device may be increased due to enabling fewer times of charging to a high state of charge. Increased lifetime of the energy storage device may lead to further reduction of total cost of operation. Furthermore, the time needed for charging may in some cases be reduced. This may also contribute to an improvement of the total cost of operation of the vehicle for reducing the time the vehicle need to be out of service due to charging.

According to a first alternative, the step of estimating virtual potential energy invested in the vehicle may comprise predicting a regenerative braking profile for the vehicle based on topographical data of a route of a planned driving assignment, and estimating, based on the predicted regenerative braking profile, an amount of energy recoverable through regenerative braking for storage in the energy storage device. Thereby, it is possible to obtain a high accuracy in the determination of the upper charging limit.

According to a second alternative, the step of estimating virtual potential energy invested in the vehicle may be performed through usage of a predetermined look-up table in combination with topographical data of a route of a planned driving assignment, said predefined look-up table defining virtual potential energy, dependent on vehicle weight and/or payload, as a function of topographical data. This has the advantage of simplifying the step of estimating virtual potential invested in the vehicle while still achieving a reliable determination of the upper charging limit. Moreover, this allows for estimating virtual potential energy even if, for example, the driving strategy of a route of the upcoming driving assignment is unknown.

The method may further comprise, when the determined maximum state of charge is lower than the determined state of charge threshold, selecting the determined state of charge threshold as the upper charging limit. This ensures that the vehicle may reach the predicted regenerative braking event and thus that the possible driving range of the vehicle is not negatively affected in case charging of the energy storage device is terminated when the determined upper charging limit is reached.

The present disclosure further provides a method, performed by a control arrangement, for controlling charging of an energy storage device of a vehicle at a charging station. Said method comprises performing the method for determining an upper charging limit as described above, and activating a charging limitation corresponding to the determined upper charging limit. Thereby, it may be ensured that the energy storage device is not charged to such a state of charge that the ability to use regenerative braking when the vehicle performs a driving assignment is negatively affected.

The method for controlling charging of an energy storage device may further comprise communicating, through usage of a user interface, information pertaining to the determined upper charging limit. In such a case, the above described step of activating the charging limitation may be performed in response to a driver-initiate request therefore. This has the advantage of enabling a driver to select whether to activate the charging limitation, which in turns also reduces the risk of the driver being surprised by the activation of the charging limitation or even concerned about the obtainable driving range after charging.

The method for controlling charging of an energy storage device may further comprise determining a charging strategy, fulfilling one or more predefined criteria, for reaching the determined upper charging limit. In such a case, the method may further comprise, when the charging limitation has been activated, controlling charging of the energy storage device in accordance with the determined charging strategy. Thereby, in addition to ensure sufficient regenerative braking ability, the greatest possible driving range may be achieved. Moreover, charging will be performed so as to meet the one or more predefined criteria.

The method for controlling charging of the energy storage device may further comprise, when the determined upper charging limit is lower than a current state of charge of the energy storage device, discharging the energy storage device at the charging station until reaching the determined upper charging limit. Thereby, the ability to use regenerative braking may be ensured even if the current state of charge of the energy storage device, when arriving at the charging station, would be higher than the determined upper charging limit. Said step of discharging the energy storage device may optionally be performed in response to a driver-initiated request therefore. Thereby, it may be avoided that the discharge is performed contrary to the driver's will.

The present disclosure further relates to a computer program comprising instructions which, when executed by a computer, cause the computer to carry out any one of the methods as described above.

The present disclosure further relates to a computer-readable medium comprising instructions which, when executed by a computer, cause the computer to carry out any one of the methods as described above.

The present disclosure further provides a control arrangement configured to determine an upper charging limit for an energy storage device of a vehicle which is to be charged at a charging station. The control arrangement is configured to determine a state of charge threshold for the energy storage device, said state of charge threshold corresponding to a minimum state of charge sufficient for the vehicle to reach a predicted upcoming regenerative braking event. The control arrangement is further configured to estimate virtual potential energy invested in the vehicle (preferably virtual potential energy invested in the vehicle for a planned driving assignment, if a planned driving assignment exists) taking into account any planned change in vehicle weight and/or payload. Furthermore, the control arrangement is configured to determine a maximum state of charge sufficient to allow the energy storage device to accumulate the estimated virtual potential energy. Moreover, the control arrangement is configured to, when the determined maximum state of charge is higher than the determined state of charge threshold, select the determined maximum state of charge as the upper charging limit.

The control arrangement provides the same advantages as described above with regard to the corresponding method for determining an upper charging limit for an energy storage device of a vehicle which is to be charged at a charging station.

The control arrangement may further be configured to activate a charging limitation, corresponding to the determined upper charging limit, to thereby control charging of the energy storage device.

The control arrangement may further be configured to communicate with a power supply arrangement of the charging station for the purpose of controlling charging of the energy storage device.

The control arrangement may also be configured to, when a current state of charge of the energy storage device is higher than the determined upper charging limit, control discharging of the energy storage device at the charging station so as to reach the determined upper charging limit.

Moreover, the present disclosure relates to a vehicle comprising the control arrangement as described above. The vehicle may be a heavy-duty vehicle, or a medium-duty vehicle, but is not limited thereto. Moreover, the vehicle may be a battery electric vehicle (BEV), a plug-in hybrid vehicle (PHEV), or a plug-in fuel cell vehicle (plug-in FCEV).

### BRIEF DESCRIPTION OF DRAWINGS

FIG. 1 schematically illustrates an example of a vehicle,

FIG. 2 schematically illustrates an example of a topographical profile of a planned driving assignment for a vehicle,

FIG. 3 represents a flowchart schematically illustrating one exemplifying embodiment of the herein described method for determining an upper charging limit for an energy storage device of a vehicle which is to be charged at a charging station,

FIG. 4 represents a flowchart schematically illustrating one exemplifying embodiment of the herein described method for controlling charging of an energy storage device of a vehicle at a charging station,

FIG. 5 schematically illustrates an exemplifying embodiment of a device which may comprise, consist of, or be comprised in the herein described control arrangement configured to determine an upper charging limit for an energy storage device of a vehicle which is to be charged at a charging station.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

The term “driver” is in the present disclosure considered to mean any person responsible for, or capable of, controlling a vehicle. Thus, the term “driver” shall therefore be interpreted broadly and includes for example any person who may fuel/recharge a vehicle (irrespectively of whether said person is also intended to operate/control the vehicle while the vehicle is in motion).

Furthermore, the term “charging station” is herein used to describe a geographical location of any form of power supply arrangement configured for recharging of a movable power consumer, such as a vehicle comprising an energy storage device. For said purpose, a charging station may comprise a power supply arrangement electrically connected to a power grid. In other words, the charging station may comprise a vehicle-to-grid (V2G) charging station. Alternatively, a charging station may comprise a power supply arrangement configured to recharge e.g. a vehicle using a (larger) stationary energy storage device. A charging station may also be a geographical location at which one vehicle is to be charged from another vehicle, i.e. a vehicle-to-vehicle (V2V) charging station. In other words, a charging station shall in the present disclosure be considered to encompass any form of V2X charging station.

A “driving assignment” is in the present disclosure considered to mean a driving mission, from a current geographical position to a destination, which may comprise one or more temporary stops. Examples of temporary stops include intermediate stops for loading/unloading of cargo, onboarding/offboarding of passengers, and/or connection/disconnection of one or more vehicle units (such as one or more trailers or the like) to the vehicle. The term “driving assignment” is in the present disclosure considered to encompass situations where the route of the driving assignment is defined or only one route option is available, as well as situations where there are multiple route options for performing the driving assignment.

In the present disclosure, the term “potential energy” is used for describing the energy stored in an object (such as a vehicle) due to its position in a gravitational field. The expression “virtual potential energy invested in the vehicle” is herein used for describing the vehicle's potential energy that is recoverable as a result of change in altitude (height above mean sea level) of a vehicle's geographical position.

The herein described methods have primarily been developed for battery electric vehicles. This type of vehicle does not include any auxiliary energy source that may be used for ensuring a desired driving range, and it is therefore critical to ensure that the vehicle is sufficiently charged for reaching a destination, such as a subsequent charging station. Moreover, it much more important to be able to ensure the ability to use regenerative braking for battery electric vehicles compared to other types of vehicles in view of their inherent lack of some other forms of auxiliary brake systems, such as various auxiliary combustion engine brake systems. However, the methods described may naturally also be used in other types of rechargeable vehicles, such as plug-in hybrids and/or plug-in fuel cell vehicles. Moreover, the herein described methods have primarily been developed for medium-duty or heavy-duty vehicles, but could also be used for other sized vehicles if desired. The herein described methods are particularly useful for heavy-duty battery electric vehicles, such as battery electric trucks or buses, in view of their weight and need for ability to use regenerative braking.

The present disclosure provides a method for determining an upper charging limit for an energy storage device of a vehicle which is to be charged at a charging station. More specifically, the present disclosure relates to a method for determining an upper charging limit for the energy storage device, wherein said upper charging limit is intended to ensure that the vehicle speed may be duly controlled, using regenerative braking, as the vehicle thereafter performs a driving assignment. Through knowledge of such an upper charging limit for the energy storage device, it is possible to provide guidance to a driver intending to charge the energy storage device and/or to control the charging process of the energy storage device of the vehicle. The method for determining an upper charging limit for an energy storage device of a vehicle which is to be charged at a charging station is performed by a control arrangement configured therefore.

The present method for determining an upper charging limit for the energy storage device comprises a step of determining a state of charge threshold, wherein said state of charge threshold corresponds to a minimum state of charge sufficient for the vehicle to reach a predicted upcoming regenerative braking event. An upcoming regenerative braking event may for example be predicted based on knowledge of an upcoming route (e.g. of a known or predicted route of a driving assignment, or a single reasonably possible route when leaving the charging station) in combination with topographical data relating to said upcoming route. In some cases, such as when the vehicle speed is to be controlled using a predictive cruise controller, there may be a planned driving strategy for the vehicle for at least an initial part of the upcoming route. In such cases, the upcoming regenerative braking event may be given by the planned driving strategy. However, in case where there is no planned driving strategy, the upcoming regenerative braking event may for example be predicted to start at a geographical position of the beginning of a decent. The minimum state of charge sufficient for the vehicle to reach the predicted upcoming regenerative braking event may for example be determined through estimating the energy needed for the vehicle to reach such a geographical position. This may be performed through any previously known method therefore, and will therefore not be described in further detail herein. It should however here be noted that, when estimating the energy needed for reaching the predicted upcoming regenerative braking event, the vehicle's weight should be taken into account. The vehicle's payload should also preferably be taken into account, or a sufficient safety margin be used in the estimation to account for such a payload (e.g., if the payload in unknown when performing the estimation of needed energy). Alternatively, the minimum state of charge sufficient for the vehicle to reach the predicted upcoming regenerative braking event may be based on historical data pertaining to the same vehicle, or other similar vehicle, travelling the same route (preferably with substantially the same payload).

The method for determining an upper charging limit for the energy storage device further comprises a step of estimating virtual potential energy invested in the vehicle, said virtual potential energy being recoverable for storage in the energy storage device through regenerative braking of the vehicle. Such a virtual potential energy may be invested in the vehicle as a result of the altitude of the vehicle when present at the charging station. Suitably, the method comprises estimating virtual potential energy invested in the vehicle for a planned driving assignment. This is possible in case there is knowledge of a planned driving assignment. It should however be noted that the herein described method may also be performed when no planned driving assignment exists, although the accuracy in the determination of the upper charging limit may in such a case be lower.

According to the herein described method, the step of estimating virtual potential energy invested in the vehicle is performed taking into account any planned change in vehicle weight and/or payload. In other words, any changes in vehicle weight and/or payload, given by e.g. a planned driving assignment, are considered when estimating the virtual potential energy invested in the vehicle. For example, a driving assignment may comprise the vehicle picking up, or leaving, one or more trailers at a geographic location, remote from the charging station, and thereafter continuing to a destination. Similarly, a driving assignment may comprise a change in payload due to loading/unloading cargo and/or onboarding/offboarding of passengers at different geographical locations before reaching a destination of the driving assignment. Considering changes in vehicle weight and/or payload is important since it may considerably alter the regenerative braking power needed for controlling the vehicle speed, and thus also the energy needed to be recovered and accumulated by the energy storage device.

The method for determining an upper charging limit for the energy storage device further comprises a step of determining a maximum state of charge sufficient to allow the energy storage device to accumulate the estimated virtual potential energy. In other words, said step comprises determining a maximum state of charge of the energy storage device that ensures that there is a reservoir in the energy storage device for accumulating potential energy recovered by regenerative braking of the vehicle.

Suitably, the maximum state of charge may be a maximum state of charge sufficient to allow the energy storage device to accumulate the estimated virtual potential energy without exceeding a predetermined state of charge limit at which the charging rate of the energy storage device needs to be reduced. This has the advantage of not only considering the availability for regenerative braking when determining the upper charging limit, but also the regenerative braking performance. Such a predetermined state of charge limit is lower than a maximum storage capacity of the energy storage device, and depends on the configuration of the energy storage device. Moreover, the possible charging rate at a higher state of charge is usually dependent of temperature of the energy storage device. Therefore, the predetermined state of charge limit may be selected in dependence of a targeted temperature, or targeted temperature interval, of the energy storage device during regenerative braking. Typically, such a predetermined state of charge limit is at least 80% of the maximum storage capacity of commonly used energy storage devices for vehicles today.

Moreover, the present method for determining an upper charging limit for the energy storage device comprises a step of, when the determined maximum state of charge is equal to or higher than the determined state of charge threshold, selecting the determined maximum state of charge as the upper charging limit. Thereby, it may be ensured that the travelling speed of the vehicle may be controlled through regenerative braking as needed for an upcoming driving assignment.

In case the determined maximum state of charge is lower than the determined state of charge threshold, the vehicle will not be able to reach the predicted regenerative braking event and the estimated virtual potential energy may therefore not be recovered. Therefore, the method may comprise a step of, when the determined maximum state of charge is lower than the determined state of charge threshold, selecting the determined state of charge threshold as the upper charging limit.

As previously described, the method suitably comprises estimating virtual potential energy invested in the vehicle for a planned driving assignment (in case a planned driving assignment is known). In such a case, the step of estimating virtual potential energy invested in the vehicle may according to a first alternative comprise predicting a regenerative braking profile for the vehicle based on topographical data of a route of a planned driving assignment. The route of the planned driving assignment may be given by the driving assignment as such. Alternatively, the route of the planned driving assignment may be a predicted route for performing the driving assignment. In the latter case, the method may further comprise a step of predicting the most likely route for performing the driving assignment. If there is only one possible route for performing the driving assignment, it is inherently the most likely route. However, in case there are multiple possible routes for performing the driving assignment, the above mentioned prediction of most likely route may be made based on historical data relating to route selections made by the vehicle and/or other similar vehicles (preferably for the driving assignment, if possible) and/or data regarding road characteristics of possible route options. Example of such road characteristics may for example include road type, speed limits, etc. The regenerative braking profile defines a variation in regenerative braking power needed or desired as a function of distance or time as the vehicle travels the route of the planned driving assignment. Based on the predicted regenerative braking profile, the amount of energy recoverable through regenerative braking for storage in the energy storage device may then be estimated. As previously described, the estimation of the virtual potential energy is performed taking into account any planned change in vehicle weight and/or payload given by the planned driving assignment. More specifically, this means that any planned change in vehicle weight and/or payload may be taken into account when predicting the regenerative braking profile. Usage of a predicted regenerative braking profile results in a high accuracy in the estimation of virtual potential energy invested in the vehicle when there is planned driving strategy for the planned driving assignment. However, a planned driving strategy may risk to be altered as the vehicle performs the driving assignment, in which case the complexity of using a predicted regenerative braking profile may not be motivated. Furthermore, there may not always be a planned driving strategy (or even a planned or predictable route) for a driving assignment, in which case a regenerative braking profile may not be predicted, at least not with sufficient accuracy.

Therefore, according to a second alternative, the step of estimating virtual potential energy invested may be performed through usage of a predetermined look-up table defining virtual potential energy, dependent on vehicle weight and/or payload, as a function of topographical data pertaining to different routes. Such a look-up table may be used in combination with topographical data relating to the (known or predicted to be most likely) route of the planned driving assignment. In its simplest form, when there are no planned changes in vehicle weight and/or payload (and the look-up table comprises data regarding virtual potential energy for the route of the actually planned driving assignment), the virtual potential energy is a function of the topography between the geographical location of the charging station and the geographical location of the vehicle's destination considering the vehicle's weight and payload. However, in case there is at least one planned change of the vehicle weight and/or payload, the estimation of virtual potential energy may comprise dividing the driving assignment into portions of substantially constant vehicle weight and payload, and determining the virtual potential energy for each such portion as a function of topography for said portion through usage of the predetermined look-up table. It should here be noted that the look-up table does not necessarily need to be predetermined for a specific route of a specific driving assignment, but rather be based on topography of a variety of road segments of possible routes for different hypothetical driving assignments. Therefore, in case the data of the look-up table comprises virtual potential energy as a function of topography of various road segments of different hypothetical routes, not corresponding to the actually planned driving assignment, the driving assignment may (additionally or alternatively) be divided into portions in the same way as described above with regard to substantially constant vehicle weight and payload. Each such portion, having a certain topography, may thereafter be compared with a road segment of the look-up table having substantially the same topography, to thereby obtain the virtual potential energy for said portion.

The virtual potential energies for the different portions may thereafter be summed up (or otherwise combined in an appropriate manner, if desired) to thereby obtain the estimated virtual potential energy of the vehicle when present at the charging station. It should here be noted that the estimated virtual potential energy for each portion of substantially constant vehicle weight and payload may be positive or negative depending on whether the altitude at the initiation of said portion is higher or lower than the altitude at the end of said portion. Although the second alternative for estimating virtual potential energy invested in the vehicle may not always provide as accurate result of the energy which may be recovered through regenerative braking, for which a reservation should be made in the energy storage device when charging at a charging station, the result in the determination of the upper charging limit will be sufficiently accurate and the step of estimating the virtual potential energy is considerably simplified. Moreover, the second alternative for estimating virtual potential energy invested in the vehicle may be performed even when a route and/or a driving strategy for the planned driving assignment are unknown. It should here be noted that although there is a planned driving assignment, there may be multiple possible routes available for performing the driving assignment.

According to a third alternative, and in case there is no planned driving assignment (and there is more than one route option when leaving the charging station), the step of estimating virtual potential energy invested in the vehicle may be performed through usage of a predetermined look-up table defining virtual potential energy, dependent on vehicle weight and/or payload, as a function of difference in altitude (i.e. height over mean sea level) of the vehicle. In its simplest form, when there are no planned changes in vehicle weight and/or payload, the virtual potential energy may be a function of the difference in altitude between the geographical location of the charging station and the average altitude of possible destinations given by map data. It should here be noted that the estimation of virtual potential energy according to the third alternative does not actually take into any topography of a route, and therefore does not lead to the same accuracy in terms of the energy being recoverable through regenerative braking. However, it may still be more useful when determining an upper charging limit for the energy storage device for the purpose of assisting a driver intending to charge the vehicle.

The upper charging limit, determined in accordance with the method described above, or other information pertaining to the determined upper charging limit, may be communicated to a driver for the purpose of assisting the driver when charging the energy storage device. Information pertaining to the determined upper charging limit may for example be communicated in the form of a recommendation on when to terminate charging (when charging at the charging station) to ensure a desirable regenerative braking ability (and suitably also regenerative braking performance). Such a communication to the driver may be performed using previously known user interface suitable therefore, including visual presentation means (such as a display) and/or audio presentation means (such as a speaker). According to one alternative, a user interface device arranged in the vehicle may be used therefore, such as a display on the vehicle's dashboard or a speaker in a driver compartment of the vehicle. The user interface may alternatively be embodied by an application in a mobile device, such as a mobile phone or a personal digital assistant (PDA) device. The user interface may also be a user interface of the charging station, such as a display or the like; suitably a user interface of a power supply arrangement of the charging station Suitably, an application in a mobile device or a user interface of the charging station may be used since this increases the likelihood of the driver taking notice of the information communicated when initiating charging at the charging station. The reason therefore is that a charging operation is typically associated with the driver being present outside the vehicle.

Alternatively, the determined upper charging limit may be used for the purpose of controlling a charging procedure of the energy storage device of the vehicle when charging at a charging station. Thus, the present disclosure further relates to a method for controlling charging of an energy storage device of a vehicle at a charging station, said method comprising performing the above described method for determining an upper charging limit. The method for controlling charging of the energy storage device further comprises a step of activating a charging limitation corresponding to the determined upper charging limit. The activation of such charging limitation automatically terminates the charging process when the determined upper charging limit is reached, even if a driver seeks to continue charging or if there is a targeted state of charge for the charging procedure which is higher than the determined upper charging limit. The charging limitation may be activated in an on-board charger of the vehicle or in the charging station without departing from the present disclosure.

The method for controlling charging of the energy storage device of the vehicle may suitably also comprise communicating, through usage of a user interface, information pertaining to the determined upper charging limit. The purpose of such a communication may be to inform the driver of the activation of the charging limitation and/or the reason therefore, and/or also to enable the driver to select whether the charging limitation should be activated (i.e. enable the driver to request activation of the charging limitation corresponding to the determined upper charging limit). As already mentioned above, such a user interface may be a user interface arranged in the vehicle, embodied as an application in a mobile device, or be a user interface of the charging station.

The activation of the charging limitation may be performed automatically or in response to a driver-initiated request therefore. Such a driver-initiated request for activation of the charging limitation may be received from the user interface used for communicating information pertaining to the determined upper charging limit, or from a different user interface, without departing from the present disclosure.

The method for controlling charging of the energy storage device may further comprise determining a charging strategy, fulfilling one or more predefined criteria, for reaching the determined upper charging limit. Examples of such predefined criteria include a desired duration of charging, a desired temperature interval of the energy storage device, reduction of energy losses during charging, and/or reduction of aging mechanisms during charging. When the charging limitation has been activated, the charging of the energy storage device may be controlled in accordance with the determined charging strategy. In essence, the method for controlling charging of the energy storage device may then be considered to use the determined upper charging limit as a targeted state of charge for the charging process, said charging process being performed in accordance with a determined charging strategy therefore.

In some cases, the upper charging limit, determined in accordance with the herein described method, may be lower than a current state of charge of the energy storage device when the vehicle reaches the charging station. In such cases, it may be advisable to seek to reduce the state of charge of the energy storage device. Therefore, the herein described method for controlling charging of an energy storage device may further comprise, when the determined upper charging limit is lower than a current state of charge of the energy storage device, discharging the energy storage device until reaching the determined upper charging limit. The charging station may be used to perform said discharge of the energy storage device. Suitably, such a step of discharging the energy storage device may be performed in response to a driver-initiated request therefore.

The performance of the herein described method for determining an upper charging limit for an energy storage device, as well as the herein described method for controlling charging of an energy storage device, may each be governed by programmed instructions. These programmed instructions may take the form of a computer program which, when executed by a computer, cause the computer to effect desired forms of control action. Such a computer may for example be comprised in the control arrangement as described herein. A computer is in the present disclosure considered to mean any hardware or hardware/firmware device implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for determining an upper charging limit for an energy storage device and/or the herein described method for controlling charging of an energy storage device. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to determine an upper charging limit for an energy storage device of a vehicle which is to be charged at a charging station. The control arrangement may be configured to perform any one of the steps of the method for determining an upper charging limit for an energy storage device as described above.

More specifically, in accordance with the present disclosure, a control arrangement configured to determine an upper charging limit for an energy storage device of a vehicle which is to be charged at a charging station is provided. The control arrangement is configured to determine a state of charge threshold for the energy storage device, said state of charge threshold corresponding to a minimum state of charge sufficient for the vehicle to reach a predicted upcoming regenerative braking event. The control arrangement is further configured to estimate virtual potential energy invested in the vehicle taking into account any planned change in vehicle weight and/or payload (such as planned changes in vehicle weight and/or payload for a planned driving assignment of the vehicle). The control arrangement is further configured to determine a maximum state of charge sufficient to allow the energy storage device to accumulate the estimated virtual potential energy. Moreover, the control arrangement is configured to, when the determined maximum state of charge is higher than the determined state of charge threshold, select the determined maximum state of charge as the upper charging limit.

The control arrangement may comprise one or more control units. In case of the control arrangement comprising a plurality of control units, each control unit may be configured to control a certain function/step or a certain function/step may be divided between more than one control units. The control arrangement may be a control arrangement of the vehicle. Alternatively, parts of the control arrangement may be arranged remotely from the vehicle, for example at a remote control center or the like.

The control arrangement may further be configured to perform the herein described method for controlling charging of an energy storage device of a vehicle at a charging station, including any one of the above described steps thereof. For example, the control arrangement may be configured to activate a charging limitation corresponding to the upper charging limit to thereby control charging of the energy storage device, either automatically or in response to a driver-initiated request therefore.

The control arrangement may be configured to communicate with a power supply arrangement of the charging station and/or a mobile device for the purpose of performing the herein described methods. In particular, the control arrangement may be configured to communicate with a user interface of a power supply arrangement of a charging station or a user interface incorporated in a mobile device.

The control arrangement may further be configured to, when a current state of charge of the energy storage device is higher than the determined upper charging limit, control discharging of the energy storage device, at the charging station, so as to reach the determined upper charging limit.

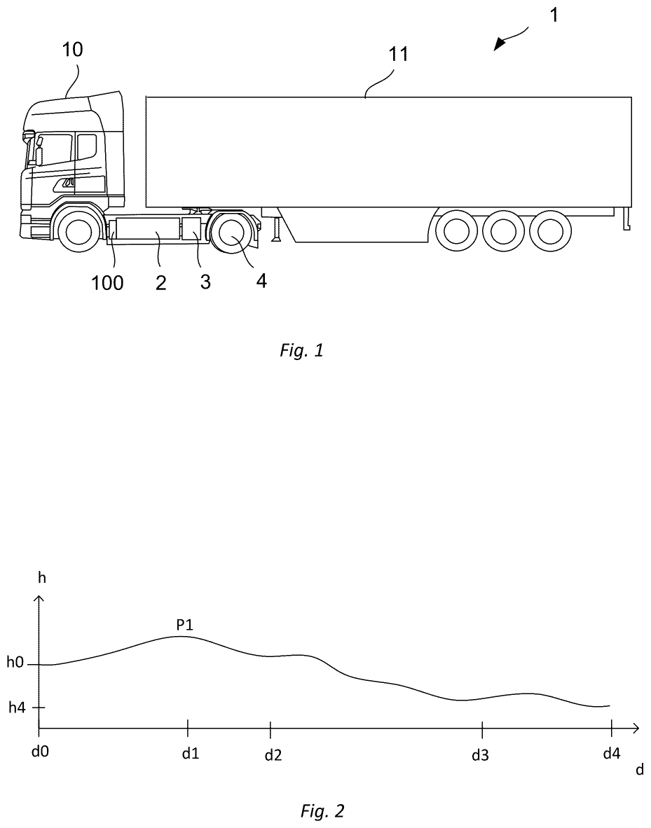

FIG. 1 schematically illustrates an example of a vehicle 1, seen in a side view. The vehicle 1 is here illustrated a semi-trailer truck.

The vehicle 1 comprises an energy storage device 2 configured to store electrical energy. Said electrical energy may be used for powering an electrical machine 3 of the vehicle 1. In other words, the energy storage device 2 is configured to power the electrical machine 3. The electrical machine 3 is in turn configured to provide propulsion torque to one or more drive wheels 4, and is thus configured to serve as a propulsion unit of the vehicle 1. Moreover, during regenerative braking of the vehicle 1, the electrical machine 3 is configured to operate as a generator to thereby convert kinetic energy from the vehicle into electrical energy, which in turn may be stored in the energy storage device 2. Thus, regenerative braking of the vehicle 1 results in charging of the energy storage device 2.

The exemplified vehicle 1 comprises a tractor truck 10 and a semi-trailer 11. The semi-trailer 11 may be disconnected from the tractor truck 10, e.g., for unloading/loading, while the tractor truck is utilized for performing other tasks, such as picking up another semi-trailer at a different location. Connecting/disconnecting a semi-trailer 11 from the tractor truck 10 changes the total weight of the vehicle 1 and may also result in changes in the payload of the vehicle. Furthermore, the payload of the vehicle 1 may be altered through changes in cargo carried by the semi-trailer 11.

The vehicle 1 may further comprise a control arrangement 100. The control arrangement 100 may be configured to perform the herein described method for determining an upper charging limit for the energy storage device 2, e.g., when the vehicle 1 is to be charged at a charging station. The control arrangement 100 may further be configured to control charging of the energy storage device 2 in accordance with the herein described method therefore.

FIG. 2 schematically illustrates an example of a topographical profile of a planned driving assignment for a vehicle, such as the vehicle 1 shown in FIG. 1. The geographical location of a charging station, at which an energy storage device of the vehicle may be charged before performing the driving assignment, is in the figure represented by a distance do. When present at the charging station, the vehicle will be at an altitude h0. Furthermore, the destination of the driving assignment is in the figure represented by distance d4. The destination of the vehicle is located at a lower altitude d4 than the altitude h0.

As evident from the illustrated example, the vehicle will, when performing the driving assignment, travel to a peak altitude reached at d1 and thereafter travel substantially downhill except for a plateau beginning at d2 and an uphill beginning at d3. Thus, it may be predicted that regenerative braking may be needed in order to control vehicle speed when the vehicle reaches d1. In other words, a predicted regenerative braking event begins at d1. In order for the vehicle to reach d1, energy will be consumed from the energy storage device in order to power a propulsion unit of the vehicle. The energy storage device therefore needs to be charged to a minimum state of charge sufficient for reaching d1. However, after d1, energy may be recovered for storage in the energy storage device through regenerative braking at least until the vehicle reaches d2. Regenerative braking may likely also be needed when the vehicle has passed the plateau beginning at d2 and until the vehicle reaches d3 at which a consumption of the stored energy may occur again. As the vehicle approaches d4, regenerative braking may again be needed in order to control vehicle speed.

Let's assume that the driving assignment comprises picking up a fully loaded trailer or a semitrailer at a pick-up P1 station located at d1. This would mean that the vehicle weight as well as payload increase at d1, and that the regenerative braking power needed as the vehicle continues to travel after d1 therefore increases compared to if such a trailer or semitrailer would not have been picked up. A situation may therefore arise that the energy needed for the vehicle to reach d1 is considerably lower than the energy recoverable through regenerative braking of the vehicle after d1. This would in turn mean that, if the energy storage device had been charged to its maximum storage capacity at the charging station, the vehicle may not be sufficiently braked through regenerative braking for the whole decent after d1. Furthermore, in view of the fact that most of the distance been d1 and d4 requires regenerative braking, the energy recoverable through regenerative braking may be considerable. It is therefore important not to charge to the energy storage device to such a high state of charge at the charging station that such regenerative braking would be impaired. This demonstrates the benefits of determining an upper charging limit for the energy storage device in accordance with the herein described method therefore, and using the determined upper charging limit for providing guidance or otherwise assisting a driver when the vehicle is to be charged at the charging station.

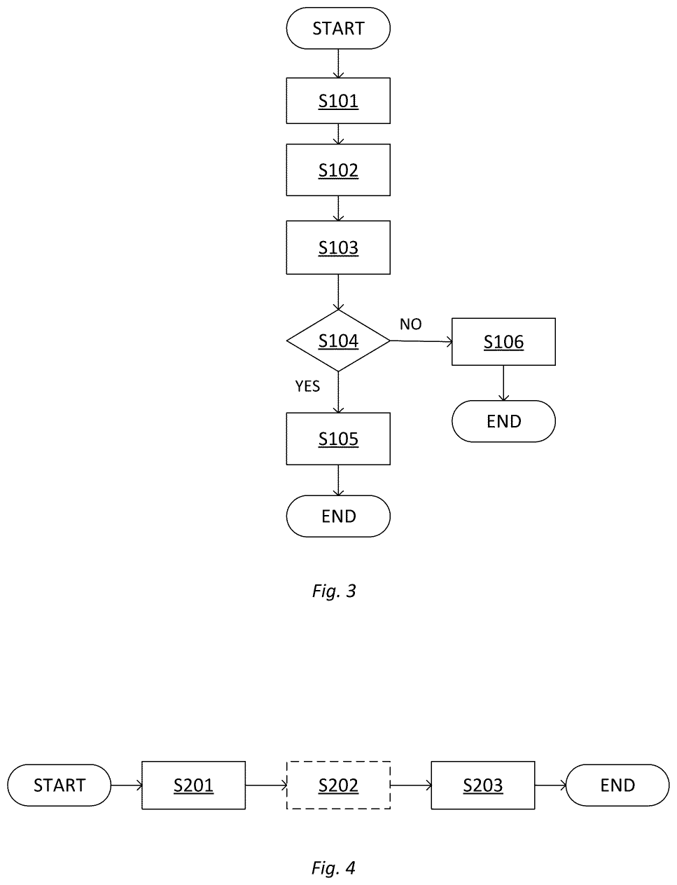

FIG. 3 represents a flowchart schematically illustrating one exemplifying embodiment of the herein described method for determining an upper charging limit for an energy storage device of a vehicle which is to be charged at a charging station.

The method comprises a step S101 of determining a state of charge threshold for the energy storage device, wherein said state of charge threshold corresponds to a minimum state of charge sufficient for the vehicle to reach a predicted upcoming regenerative braking event.

The method further comprises a step S102 of estimating virtual potential energy invested in the vehicle, when present at the charging station. Said estimation of virtual potential energy invested in the vehicle is performed taking into account any planned change in vehicle weight and/or payload as given by a planned driving assignment.

Furthermore, the method comprises a step S103 of determining a maximum state of charge of the energy storage device sufficient to allow the energy storage device to accumulate the estimated virtual potential energy.

It should here be noted that although step S101 is illustrated to be performed prior to the steps S102 and S103, step S101 may alternatively be performed in parallel with, or after, any one of the steps S102 and S103.

The method further comprises a step S104 of determining whether the determined maximum state of charge, obtained from step S103, is (equal to or) higher than the determined state of charge threshold, obtained from step S101. If so, the method proceeds to a step S105 of selecting the determined maximum state of charge as the upper charging limit.

However, in case it is determined in step S104 that the determined maximum state of charge is lower than the determined state of charge threshold, the method may proceed to a step S106 of selecting the determined state of charge threshold as the upper charging limit.

The method may be ended after any one of steps S105 and S106.

FIG. 4 represents a flowchart schematically illustrating one exemplifying embodiment of the herein described method for controlling charging of an energy storage device of a vehicle when charging station.

The method for controlling charging of an energy storage device comprises a step S201 of performing the method for determining an upper charging limit as described herein, for example in accordance with the exemplifying embodiment illustrated in FIG. 3.

The method for controlling charging of an energy storage device may optionally comprise a step S202 of communicating, through usage of a user interface, information pertaining to the determined upper charging limit, and suitably also enabling the driver (e.g. via the user interface) to request activation of a charging limitation corresponding to the determined upper charging limit.

The method for controlling charging of an energy storage device further comprises a step S203 of activating a charging limitation corresponding to the determined upper charging limit.

The method may for example be ended when charging of the energy storage device has been completed.

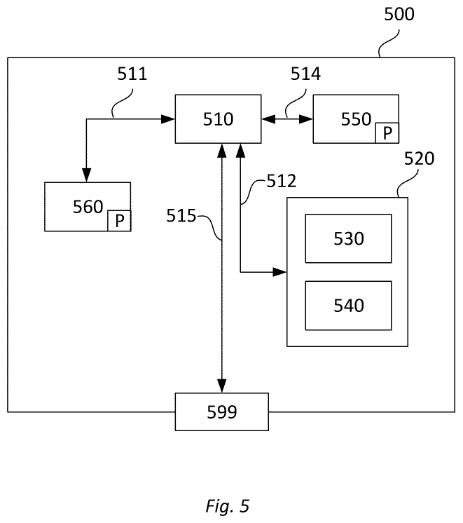

FIG. 5 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for determining an upper charging limit for an energy storage device of a vehicle which is to be charged at a charging station. The computer program comprises instructions for determining a state of charge threshold for the energy storage device, said state of charge threshold corresponding to a minimum state of charge sufficient for the vehicle to reach a predicted upcoming regenerative braking event. The computer program further comprises instructions for estimating virtual potential energy invested in the vehicle, wherein said estimation is performed taking into account any planned change in vehicle weight and/or payload. The computer program also comprises instructions for determining a maximum state of charge sufficient to allow the energy storage device to accumulate the estimated virtual potential energy. Moreover, the computer program comprises instructions for, when the determined maximum state of charge is higher than the determined state of charge threshold, selecting the determined maximum state of charge as the upper charging limit.

The computer program may further comprise instructions for controlling charging of the energy storage device at a charging station. For example, the computer program may comprise instructions for activating a charging limitation corresponding to the determined upper charging limit.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be effected by the device 500 by means of the data processing unit 510 which runs the program stored in the memory 560 or the read/write memory 550. When the device 500 runs the program, methods herein described are executed.

1. A method, performed by a control arrangement, for determining an upper charging limit for an energy storage device of a vehicle which is to be charged at a charging station, the method comprising:
determining a state of charge threshold for the energy storage device, said state of charge threshold corresponding to a minimum state of charge sufficient for the vehicle to reach a predicted upcoming regenerative braking event;
estimating virtual potential energy invested in the vehicle, wherein said estimation is performed taking into account any planned change in vehicle weight and/or payload;
determining a maximum state of charge sufficient to allow the energy storage device to accumulate the estimated virtual potential energy; and
when the determined maximum state of charge is higher than the determined state of charge threshold, selecting the determined maximum state of charge as the upper charging limit.

2. The method according to claim 1, wherein estimating virtual potential energy invested in the vehicle comprises:
predicting a regenerative braking profile for the vehicle based on topographical data of a route of a planned driving assignment; and
based on the predicted regenerative braking profile, estimating an amount of energy recoverable through regenerative braking for storage in the energy storage device.

3. The method according to claim 1, wherein estimating virtual potential energy invested in the vehicle is performed through usage of a predetermined look-up table in combination with topographical data of a route of a planned driving assignment, said predefined look-up table defining virtual potential energy, dependent on vehicle weight and/or payload, as a function of topographical data.

4. The method according to claim 1, further comprising:
when the determined maximum state of charge is lower than the determined state of charge threshold, selecting the determined state of charge threshold as the upper charging limit.

5. A method, performed by a control arrangement, for controlling charging of an energy storage device of a vehicle at a charging station, said method comprising:
determining an upper charging limit for an energy storage device of a vehicle which is to be charged at a charging station, said determining the upper charging limit comprising:
determining a state of charge threshold for the energy storage device, said state of charge threshold corresponding to a minimum state of charge sufficient for the vehicle to reach a predicted upcoming regenerative braking event;
estimating virtual potential energy invested in the vehicle, wherein said estimation is performed taking into account any planned change in vehicle weight and/or payload;
determining a maximum state of charge sufficient to allow the energy storage device to accumulate the estimated virtual potential energy; and
when the determined maximum state of charge is higher than the determined state of charge threshold, selecting the determined maximum state of charge as the upper charging limit; and
activating a charging limitation corresponding to the determined upper charging limit.

6. The method according to claim 5, further comprising:
communicating, through usage of a user interface, information pertaining to the determined upper charging limit; and
wherein the activation of the charging limitation is performed in response to a driver-initiated request therefore.

7. The method according to claim 5, further comprising:
determining a charging strategy, fulfilling one or more predefined criteria, for reaching the determined upper charging limit; and
when the charging limitation has been activated, controlling charging of the energy storage device in accordance with the determined charging strategy.

8. The method according to claim 5, further comprising:
when the determined upper charging limit is lower than a current state of charge of the energy storage device, discharging the energy storage device at the charging station, until reaching the determined upper charging limit.

9. A computer program product stored on a non-transitory computer-readable medium, said computer program product for determining an upper charging limit for an energy storage device of a vehicle which is to be charged at a charging station, wherein said computer program product comprising computer instructions to cause one or more computer processors to perform the following operations:
determining a state of charge threshold for the energy storage device, said state of charge threshold corresponding to a minimum state of charge sufficient for the vehicle to reach a predicted upcoming regenerative braking event;
estimating virtual potential energy invested in the vehicle, wherein said estimation is performed taking into account any planned change in vehicle weight and/or payload;
determining a maximum state of charge sufficient to allow the energy storage device to accumulate the estimated virtual potential energy; and
when the determined maximum state of charge is higher than the determined state of charge threshold, selecting the determined maximum state of charge as the upper charging limit.

10. (canceled)

11. A control arrangement configured to determine an upper charging limit for an energy storage device of a vehicle which is to be charged at a charging station, the control arrangement being configured to:
determine a state of charge threshold for the energy storage device, said state of charge threshold corresponding to a minimum state of charge sufficient for the vehicle to reach a predicted upcoming regenerative braking event;
estimate virtual potential energy invested in the vehicle taking into account any planned change in vehicle weight and/or payload;
determine a maximum state of charge sufficient to allow the energy storage device to accumulate the estimated virtual potential energy; and
when the determined maximum state of charge is higher than the determined state of charge threshold, select the determined maximum state of charge as the upper charging limit.

12. The control arrangement according to claim 11, further configured to activate a charging limitation, corresponding to the determined upper charging limit, to thereby control charging of the energy storage device.

13. The control arrangement according to claim 11, further configured to communicate with a power supply arrangement of the charging station for the purpose of controlling charging of the energy storage device.

14. The control arrangement according to claim 13, further configured to:
when a current state of charge of the energy storage device is higher than the determined upper charging limit, control discharging of the energy storage device at the charging station so as to reach the determined upper charging limit.

15. A vehicle comprising a control arrangement configured to determine an upper charging limit for an energy storage device of a vehicle which is to be charged at a charging station, the control arrangement being configured to:
determine a state of charge threshold for the energy storage device, said state of charge threshold corresponding to a minimum state of charge sufficient for the vehicle to reach a predicted upcoming regenerative braking event;
estimate virtual potential energy invested in the vehicle taking into account any planned change in vehicle weight and/or payload;
determine a maximum state of charge sufficient to allow the energy storage device to accumulate the estimated virtual potential energy; and
when the determined maximum state of charge is higher than the determined state of charge threshold, select the determined maximum state of charge as the upper charging limit.

16. The method according to claim 5, further comprising:
when the determined upper charging limit is lower than a current state of charge of the energy storage device, discharging the energy storage device at the charging station, until reaching the determined upper charging limit; and
wherein discharging the energy storage device is performed in response to a driver-initiated request therefore.
